(19) United States
(12) Patent Application Publication
(10) Pub. No.: US 2026/0300868 A1
(43) Pub. Date: Oct. 1, 2026

(54) Information Processing Apparatus and Method for Kanban Board-Style Calculation User Interface

(71) Applicant: Peace and Passion Inc., Tsukuba (JP)

(72) Inventors: Satoshi HIRANO, Tsukuba (JA); Kazuki AIKAWA, Tsukuba (JP)

(21) Appl. No.: 19/630,951

(22) Filed: Mar. 27, 2026

(30) Foreign Application Priority Data
Mar. 31, 2025 (JP) 2025-59534

(51) Int. Cl. G06Q 10/0631; G06F 7/544; G06F 9/451

(52) U.S. Cl. CPC G06Q 10/06316; G06F 7/544; G06F 9/451

(57) ABSTRACT

Provided is an information processing apparatus integrating Kanban-style task management with spreadsheet-like price simulation and budget management without formula inputs. A user interface displays a board having rows, each containing movable cards and optional operators. An array of cards in a row is evaluated as an expression to calculate the row's numerical value. A reference card incorporates another row's value into the expression. An operator can be automatically selected based on numerical properties (e.g., monetary amount vs. quantity), enabling calculation solely by card arrangement. The apparatus comprises a card processing unit managing cards and reference cards, a circular reference detection data structure, and a row processing unit. The row processing unit sequentially retrieves cards, recursively evaluates referenced rows while preventing circular references, and computes the expression to display the row's numerical value.

### CROSS-REFERENCE TO RELATED APPLICATIONS

This application claims priority to Japanese Patent Application No. 2025-059534, filed on Mar. 31, 2025, the entire contents of which are incorporated herein by reference.

### BACKGROUND

### Field of the Invention

The present disclosure relates to user interface technology for task management and spreadsheet calculation.

### Description of the Related Art

A new user interface is disclosed that integrates task management by moving cards, product selection, and spreadsheet-like price simulation and budget management in a Kanban-style board.

In this specification, preparation for a wedding in a format common in the United States, such as “deciding on a venue such as a park or city hall and arranging catering food,” is taken as an example. Operations such as what needs to be done before the wedding, creating a budget plan, managing expenditures, and selecting food and guests are used as examples.

In managing such complex tasks, a “Kanban board” as shown in FIG. 1 or a checklist using spreadsheet software is often used. Traditional Kanban boards, despite their suitability for visual task management, do not support calculation, which compels the integration of spreadsheet-based functional units.

FIG. 1 shows an example of a Kanban board, which models the task management of a wedding. A board 10 includes a row 20, a row 30, and a row 40, and these rows include to-do tasks, in-progress tasks, and completed tasks, respectively. Typically, Kanban columns (swimlanes) are vertical, but in the present invention, they are arranged horizontally as rows in accordance with the Banban board described later.

A user moves cards to the lower row according to the progress of work. For example, the user moves a card 33 from the row 20 to the row 30. Then, the Kanban board moves a card 24 and a card 25 to the left to fill the space where the card 33 was.

FIG. 2 shows an example of spreadsheet software, which simulates a budget by changing the unit price of food and the number of guests. A catering company or a wedding planner may present it as an estimate.

A user inputs calculation formulas as shown in FIG. 2(a) and obtains results as shown in FIG. 2(b). For example, in food catering, if the unit price of the food is $110 and the number of guests is 50, an amount 60 is calculated to be $5500 according to a formula 50. In addition, labor costs and tableware rental fees are recorded, and a fictitious tax amount is added.

As a user interface, there are problems such as that it is difficult to create formulas, easy to make mistakes, and difficult to notice calculation mistakes. For example, what is displayed on the sheet is the calculation result (b), and the basis (a) of the calculation is invisible.

As a related art that integrates a Kanban board for task management and calculation, Patent Document 1 (U.S. Pat. No. 10,496,962B1) discloses a technique for aggregating point values included in cards and displaying them on a scoreboard. Since it is a task management technology, points represent the “importance” of tasks, and aggregation means “how many points were achieved yesterday, how many points were achieved last month.” Regarding the integration of spreadsheets and other technologies, Patent Document 2 (U.S. Pat. No. 7,350,141B2) discloses a technique for embedding a spreadsheet in HTML.

Non-Patent Document 1 (Inogic, ISV, “Data-Driven Decision Making with Aggregated Numerical Values in Kanban Boards”, Sep. 29, 2023, CRM Software Blog) describes a technique for displaying the sum of numerical values included in cards in a row.

FIG. 3 shows an example of “Banban Board (registered trademark)” of the applicants disclosed in Non-Patent Document 2 (Peace and Passion, “Requestland and Banban Board”, Feb. 6, 2021). Although similar to a Kanban board, it is used for comparing, examining, and selecting a plurality of candidates when purchasing some articles. It has a function of displaying the sum of numerical values included in cards, but does not include a general-purpose spreadsheet calculation function as in the present invention. Since this is the basic technology of the present invention, a simple example is shown here, and it is expanded to include a spreadsheet function (novelty) in the embodiments.

A user creates cards for various products and services found in various online shops, and makes a selection by moving the cards.

In FIG. 3(a), a row 110 has a card 112 for Food A at $80, a card 113 for Food B at $120, and a card 114 for Food C at $150 as candidates for catering food.

When the user drags a page found on a browser onto the Banban board, the Banban board generates a card including a title, a price, and a picture of food, as shown in the card 114.

A row 120 in FIG. 3(a) is a row for selecting food and calculating the fee for one guest, and initially includes cards for drinks and desserts, indicating that the added amount 121 is $30. In this way, calculations are automatically performed by arranging cards including prices.

Here, the user chooses one of the three food candidates. For example, as shown in FIG. 3(b), the user moves the card 112 for Food A from the row 110 to the row 120. Then, the unit price 121 of the food becomes $110. Alternatively, a method of copying the card 112 and then moving it, leaving the three foods in the row 110, may be used. When the user moves the card 112 from the row 110 to the row 120, the Banban board moves the card 113 and the card 114 to the left to fill the space where the card 112 was.

### CITATION LIST

### Patent Literature

Patent Document 1: U.S. Pat. No. 10,496,962 B1
Patent Document 2: U.S. Pat. No. 7,350,141 B2
Patent Document 3: Japanese Patent Application No. 2024-202826

### Non-Patent Literature

Non-Patent Document 1: Inogic, ISV, “Data-Driven Decision Making with Aggregated Numerical Values in Kanban Boards”, [online], Sep. 29, 2023, CRM Software Blog, [retrieved on Mar. 26, 2025], Internet <URL: https://www.crmsoftwareblog.com/2023/09/data-driven-decision-making-with-aggregated-numerical-values-in-kanban-boards/>
Non-Patent Document 2: Peace and Passion, “Requestland and Banban Board”, [online], Feb. 6, 2021, Peace and Passion, Requestland (R), [retrieved on Mar. 26, 2025], Internet <URL: https://request.land>

### BRIEF SUMMARY OF THE INVENTION

In life and work, there are many opportunities to select articles to purchase, manage things to do, and calculate costs using a spreadsheet. For example, in marriage, there is a continuous series of opportunities to process tasks, select articles, and calculate costs, such as deciding on a wedding ceremony, moving to a new house, purchasing furniture and home appliances, and planning flights and hotels for a honeymoon.

A first problem to be solved by the present invention is to realize a user interface that integrates such four operations of selecting articles to purchase, managing tasks, simulating purchase prices, and managing budgets, making it possible to perform them with fewer procedures, high visibility, and with fewer mistakes.

A second problem to be solved by the present invention is to realize a user interface that enables budget calculation, estimation, and price comparison simulation as shown in FIG. 2 without inputting a single calculation formula such as “=sum(D2:D4)”.

FIG. 4 shows an example in which an arithmetic expression specified by relative cells, which is a feature of spreadsheets, is combined with a Kanban board to calculate a food budget equivalent to that in FIG. 2.

A card 232 calculates an amount of $5500 by multiplying $150 of a card 212 located above and 50 of a card 222 by an expression 235 including vertical relative card specification. If the amounts of labor cost and tableware are similarly multiplied by relative card specification, it is possible to calculate $9130 as a total 241 by adding them.

However, when a user moves any card included in a row 210 or a row 220 to another row, due to the characteristics of the Kanban board, cards on the right side move to fill the gap where the card was. The relative specification shifts, and the calculation no longer matches. This acts as a technical obstacle, and a simple combination of a Kanban board and a spreadsheet calculation is not established.

In order to solve the above problems, an information processing apparatus implementing a Kanban board-style calculation user interface including one or more rows, each row having a row identifier and including one or more cards addable or movable by an input device, the apparatus comprising: a processor; a memory; a board processing unit executable by the processor, holding a board having a capability of forming calculation expressions having dependencies from reference relationships defined by the row identifiers, between the cards displaying a numerical value and the rows, and performing evaluation of an expression of each row by dynamically reconstructing the expression and updating the numerical value in response to movement of the cards, without requiring expression input by a user; a card processing unit executable by the processor to store, in the memory, the one or more cards each being either a numerical value card displaying a title and a numerical value, or a reference card storing the row identifier of a referenced row and displaying a numerical value of the referenced row; a circular reference detection data structure stored in the memory for confirming that the reference card is not a circular reference; and a row processing unit executable by the processor to store, in the memory, one or more rows each including: a row identifier; a list of the one or more cards and zero or more operators; a numerical value of the row displayed on the row; and an expression data structure storing an expression comprising numerical values displayed by the one or more cards and the zero or more operators, the row processing unit, upon addition or movement of a card, repositioning other cards within the list, and each time retrieving the numerical values displayed by the one or more cards included in the row, evaluating using the expression data structure with the operator between the cards if present or as addition if no operator is present, and displaying the numerical value of the row as a result of the calculation; wherein, in response to addition or movement of the card, the row processing unit is configured to, for evaluating the expression of each changed row: sequentially retrieve one card or, if present, one of the operators from the list held by the row; in a case where the retrieved card is a reference card, recursively evaluate an expression in a row referenced by the row identifier held by the reference card, after confirming that the reference card is not a circular reference using the circular reference detection data structure, and cause the reference card to store and display a numerical value of an obtained result; in a case where the retrieved card is a numerical value card, retrieve the numerical value of the card from the card processing unit; store the numerical value obtained in the foregoing cases or the retrieved operator, in the expression data structure in the memory; after completing retrieval of all of the cards and, if present, the operators included in the list, evaluate, as an expression, the stored numerical values and, if present, the stored operators included in the expression data structure, with addition applied where no operator is present between numerical values, and display a result as a numerical value of the row; and if the evaluation is performed as a recursive call, return the result to the row processing unit.

### Advantageous Effects of the Invention

According to the present invention, in addition to task management, calculations such as budget calculation, estimation, and price comparison simulation, which have conventionally been performed using spreadsheet calculations, are realized by a user interface that enables calculations by moving cards without inputting any calculation formulas.

For example, when a user calculates a total of subtotals in a spreadsheet calculation, the user must know a method of inputting a calculation formula into a specific cell of a row and referring to it by a relative reference. Further, when the cell specification by spatial coordinates of the spreadsheet calculation is combined with a Kanban board, there is a problem that the specified position shifts due to the movement of a card, and the calculation breaks down.

In the present invention, since the row itself has a numerical value, an implicit row operation rule, and a row identifier, calculation of a subtotal is executed merely by placing a numerical value card, and even if the user rearranges cards or rows, the row dynamically reconstructs a mathematical expression and updates the numerical value by sequentially retrieving cards and operators from a “list held by the row”. Also, on the side of a card referring to the row and calculating a total, it is possible to refer to a numerical value by the row identifier without depending on spatial cell coordinates. These are technical effects not found in conventional user interfaces.

Furthermore, the present invention provides a specific user interface architecture that directly links the movement operation of a card on a display screen with the addition/deletion of elements to/from a circular reference detection data structure and an expression data structure by a processor. This integrates task progress management and complex calculation processing, which were conventionally separated, by a single operation, eliminates time, effort, and calculation errors when using separate software, and has the effect of dramatically improving the function itself of the user interface in the information processing apparatus.

In addition, by managing and evaluating the reference relationships among cards and rows as a circular reference detection data structure and a dependency graph, it is possible to skip rows for which re-evaluation of calculation formulas is unnecessary. This has the effect of dramatically reducing the calculation load of the processor and the number of accesses to the memory, and improving the response speed of the system, which is an improvement in the function of the computer itself.

### BRIEF DESCRIPTION OF THE SEVERAL VIEWS OF THE DRAWING

FIG. 1 is a view showing an example of a related-art Kanban board.

FIG. 2 is a view showing an example of aggregation of estimates in a related-art spreadsheet.

FIG. 3 is a view showing an example of automatic calculation of row totals in a Kanban board-style calculation user interface according to an embodiment.

FIG. 4 is a view showing an example of aggregation and estimation using relative reference.

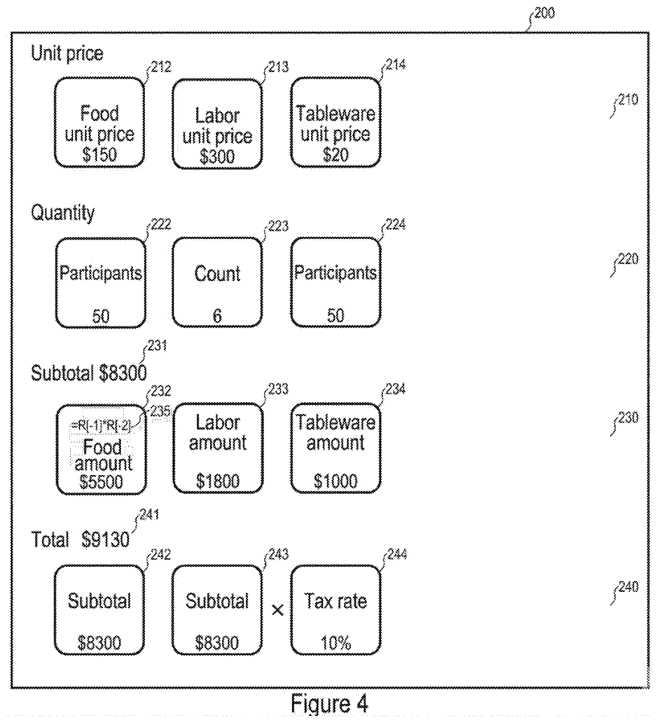

FIG. 5 is a view showing an example of automatic calculation of total cost using reference cards from a food unit price and a number of participants.

FIG. 6 is a view showing how a total cost changes through reference cards when a food item is changed.

FIG. 7 is a block diagram showing components of an information processing apparatus according to an embodiment.

FIG. 8 is a flowchart showing a row evaluation process performed by a row processing unit.

FIG. 9 is a view showing a state before changing a food item included in a food unit price.

FIG. 10 is a view showing how a food unit price and a total cost change through a selection function when a food item in the food unit price is changed.

FIG. 11 is a view showing creation of an estimate without the need for inputting an expression.

FIG. 12 is a view showing an example of task management and budget management for a wedding.

### DETAILED DESCRIPTION OF THE INVENTION

### First Embodiment

The present invention is a new user interface that integrates task management by moving cards, product selection, and spreadsheet-like price simulation and budget management.

The difference from the conventional technology is that, in a Kanban-style board, an array of cards included in a row is regarded as an expression, a result of evaluating the expression thereof is set as a numerical value of the row, a numerical value of another row is incorporated into the expression by a reference card, and an operator is automatically selected depending on a property of a numerical value (monetary amount and quantity), whereby inputting an expression is made unnecessary, and calculation is performed by arrangement and movement of cards.

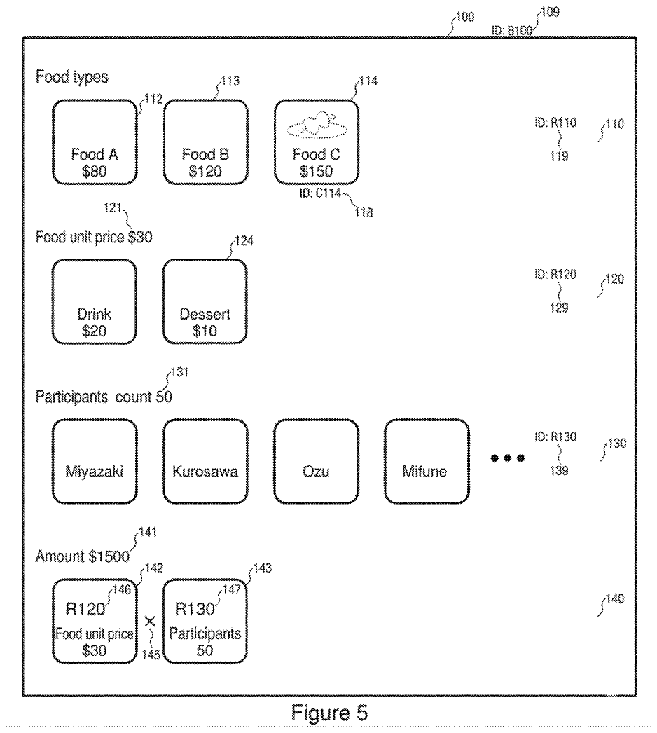

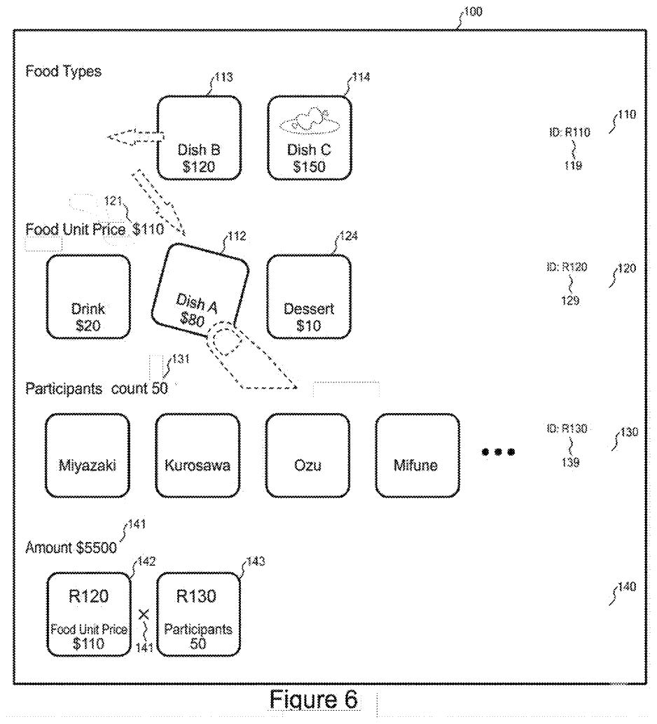

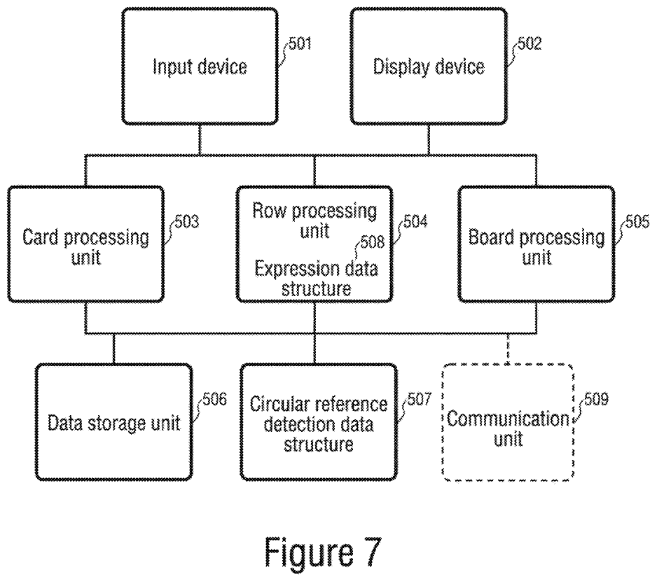

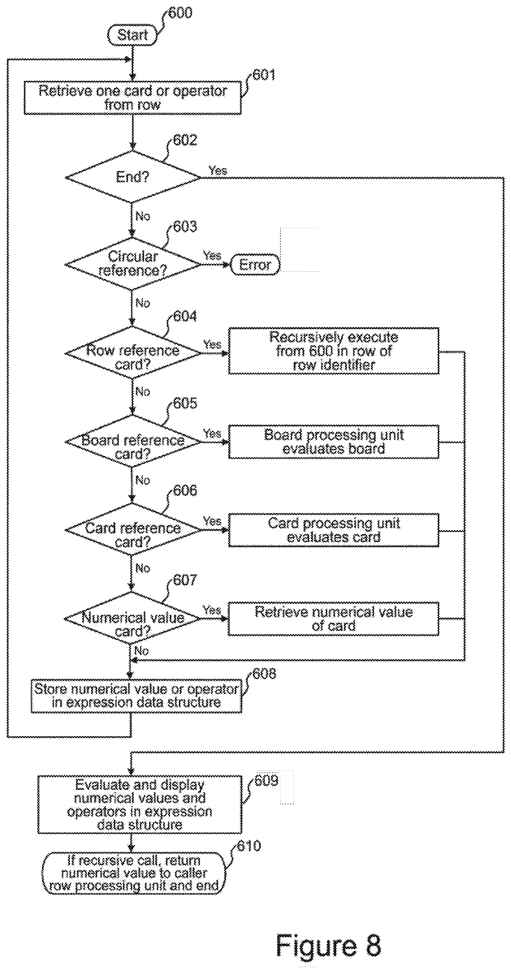

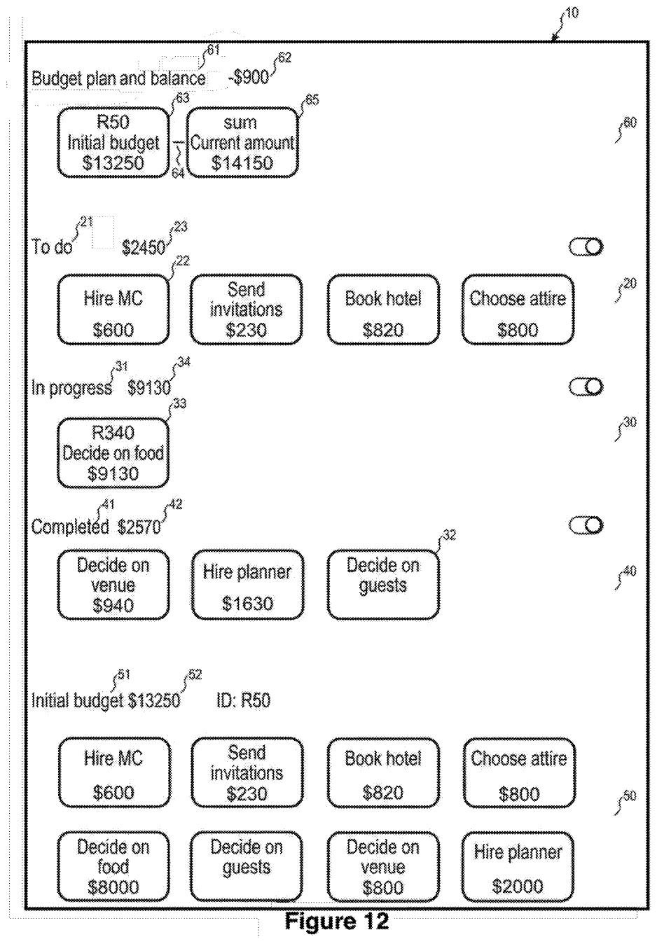

FIG. 12 shows an example in which such task management, product selection, price simulation, and budget management are integrated. Aiming at this, first, an example of determining a unit price of food per participant using a “reference card”, determining the number of participants, and calculating the amount of food, which is a basic embodiment of the Banban-calc of the present invention, will be described with reference to FIGS. 5 and 6. Thereafter, components and a processing method will be described using the diagrams of FIGS. 7 and 8.

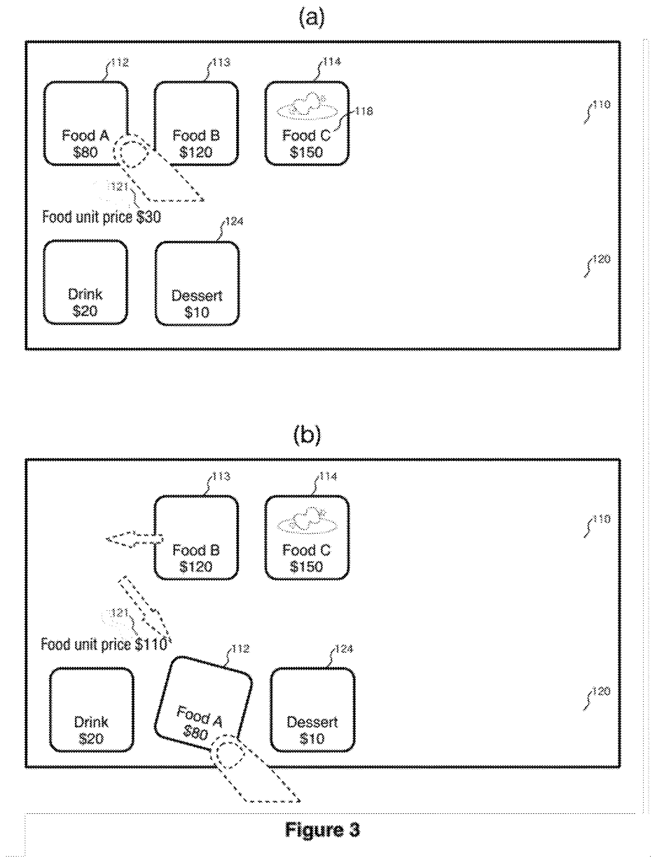

FIG. 5 shows a state in which the Banban board of FIG. 3 is expanded to automatically calculate an amount using reference cards from a food unit price and participants.

In FIG. 5, a row 110 includes cards for three types of food that are candidates for purchase. Like a card 114, a card displays a title and a numerical value, and includes a card identifier 118 inside. It is easy to use if there is an image, but it is not essential. A row includes a row identifier 119. The identifier is, for example, a key value on a database, a long character string, or an index number.

A row 120 is for selecting food and calculating a unit price, and cards for drinks and desserts are temporarily placed there. A numerical value 121 of the row is calculated by regarding the numerical values of the cards included in the row as an expression, and here it is an amount of $30 obtained by adding $20 for drinks and $10 for desserts.

A row 130 is a list of participants, and in the example, 50 people are expected to be invited. A numerical value 131 of the row is calculated as the number of cards (count). In order to consider who to invite, the user may add a row (not shown) and replace candidate cards with the row 130.

Such processing of “regarding the arrangement of cards as an expression and evaluating it” is referred to as row expression evaluation. As operations between cards (row operations) used in row expression evaluation, addition is an implicit operation, and other conceivable operations include multiplication, average, a count for counting the number of cards included in a row, user-defined functions, and the like, which are saved as row attributes.

If none of the cards in the row has a numerical value, an effect is obtained that the user does not need to specify a row operation if a row processing unit 504 described later automatically selects counting of the number of cards.

In a row 140, a card 142 having a food unit price of $30, an operator 145 for multiplication, and a card 143 having the number of participants of 50 are arranged, and a numerical value 141 of the row is $1500.

An operator between cards is for designating an operation different from a row operation uniformly applied to cards, and is multiplication, division, subtraction, parentheses, built-in functions such as log, user-defined functions, and the like. For example, if the row operation of the row 140 is addition, and a card of $20 and a card of $10 are added, the expression becomes [Math. 1], and an amount 141 after evaluating the row expression becomes $1530.

$$\$30 * 50 + \$20 + \$10 \qquad [ Math . 1 ]$$

As the implementation of the operator, a form as an attribute attached to a card, a form as a kind of card, and a form as other data between cards are conceivable.

The card 142 for the food unit price is a reference card referring to the row 120. It holds R120 pointing to the row 120 as a row identifier 146, and displays $30 of the numerical value 121, which is the result of evaluating the expression of 120. Similarly, the card 143 for the number of participants is a reference card referring to the row 130 by R130 of an identifier 147, and displays 50 of the numerical value 131, which is the result of evaluating the expression of the row 130.

Here, as shown in FIG. 6, when the card 112 for food A in the row 110 is moved to the row 120, the expression in the row 120 is evaluated, and the numerical value 121 of the row for the food unit price becomes $110. Furthermore, the numerical value of the reference card 142 also becomes $110, and the amount 141 is updated to $5500.

Types of such reference cards include reference cards to cards and board reference cards (reference cards to boards), in addition to references to rows. In this specification, the mechanism of reference to a row will be described in detail. Other references have similar mechanisms.

Methods for the user to create a reference card include a form in which when the user drags a title or numerical value of a row to another row, a reference card referring to the row is created, a form using an instruction input unit or an input device such as a button, a switch, voice, or text for the user to create a reference card, and a form using a predetermined rule or AI.

Next, the components and processing methods of the present invention will be described with reference to FIGS. 7 and 8.

When the user creates or operates a card, a row, and a board using an input device 501, a card processing unit 503, a row processing unit 504, and a board processing unit 505 respectively perform creation and operation processing, and display results on a display device 502. In a general programming language, each processing unit would be implemented as a card object, a row object, and a board object, and executed using a processor and memory.

A data storage unit 506 is a database or a file, and each processing unit stores data in the data storage unit 506 each time the user creates or operates it. In order to avoid complicating the following description, it is assumed that such display and storage are implicitly executed.

The card processing unit 503 (card object) represents one card as shown in the card 114. It holds the card identifier 118, displays a title and a numerical value, and performs processing thereof. When the card is the reference card 142, it also holds the reference destination identifier 146 and displays the numerical value of the reference destination.

The row processing unit 504 (row object) represents one row as shown in the row 110 and performs processing thereof. It includes the row identifier 119 and holds and displays a title and a list of cards (card objects). The list of cards may include operators. An arrangement of these cards is regarded as an expression and evaluated, and the resulting numerical value 141 is displayed. Since operators have priorities, an expression data structure 508 that temporarily stores numerical values and operators is used for the evaluation.

The board processing unit 505 (board object) represents one board as shown in the board 100 and performs processing thereof. It includes a board identifier 109 and holds and displays a list of rows (row objects). It forms calculation expressions having dependencies from reference relationships defined by the row identifiers between the cards displaying a numerical value and the rows, and performs evaluation of an expression of each row by dynamically reconstructing the expression and updating the numerical value in response to movement of the cards, without requiring expression input by a user.

Next, a method for evaluating an expression of a row including a reference card, which is a feature of the present invention, will be described. Note that it differs greatly from conventional spreadsheets in the following points, and requires a unique method.

Present invention: A row forms one arithmetic expression including a plurality of cards, and displays a numerical value as a result of evaluating the arithmetic expression.

Spreadsheet: A row is a set of cells, does not form an arithmetic expression as a row, and does not display a numerical value. Individual cells contain formulas.

Present invention: A row reference card refers to a row as a whole.

Spreadsheet: A cell cannot refer to a row as a whole. It is possible to refer to cells included in a row, such as 2:2.

Present invention: When a user moves one card, other cards are automatically moved to fill the position.

Spreadsheet: Cells do not move unless the user moves them.

Present invention: A card displays a title and a numerical value.

Spreadsheet: A cell displays either a text or a numerical value.

When the user performs some operation, or when a board is loaded from the data storage unit 506 or a communication unit 509, the board processing unit 505 causes the row processing unit 504 to evaluate and display the expression of the row for each row included in the board.

Then, the row processing unit 504 executes a row expression evaluation process including the following steps shown in FIG. 8.

In step 601, one card or operator is sequentially retrieved from the held list of cards.

In step 602, it is determined whether or not processing of all the cards has been completed, and if so, a transition is made to step 609.

In step 603, if the retrieved card is a row reference card, it is confirmed using a circular reference detection data structure 507 that no circular reference (an infinite loop of reference relationships in which the expression evaluation process never stops) has occurred.

Specifically, if the row identifier being evaluated in the expression evaluation process of the current row exists in the circular reference detection data structure 507, an error occurs. Otherwise, the row identifier under evaluation is temporarily recorded in the circular reference detection data structure 507, and is deleted in an end step 610. The same applies to card references and board references.

In step 604, it is determined whether or not the card is a reference card to a row, and if so, processing similar to the expression evaluation process of this row is recursively applied to the row referred to by the row identifier, and the obtained numerical value is displayed on the reference card. For example, if there is a reference card 142 while evaluating the row 140, a row expression evaluation process is performed in the row 120 referred to by the row identifier 146, and $30 of the result 121 is displayed on the card 142.

Step 605 is processing of a board reference card, and step 606 is recursive processing of a reference card to a card. The content is the same as in step 604.

In step 607, if the card is a numerical value card, the numerical value is retrieved from the card processing unit. In the case of an arithmetic expression such as $30*4, a result of evaluating the expression is set as a numerical value. If the arithmetic expression in the card includes a reference, processing similar to step 604 is performed.

Here, assuming that cards are obtained in the order of $40, +, and $50, operators having higher priorities such as * and 3 may appear later, so that operations cannot be performed in the order in which the cards and operators are taken out. Therefore, in step 608, the evaluated numerical value or operator obtained above is stored in the expression data structure 508 unique to the row.

The row expression evaluation process returns to step 601 to process the next card.

When the processing of all the cards is completed, the expression stored in the expression data structure 508 is evaluated in step 609, and the result is displayed in the row. The food unit price 121, the number of participants 131, and the amount 141 are examples thereof. In step 610, if the process has been called recursively from step 604, the numerical value is returned to the calling row processing unit and the process terminates.

For the evaluation of the expression, a general algorithm such as reverse Polish notation, recursive descent parser, or abstract syntax tree may be used. In step 608, data according to the algorithm is stored in the expression data structure 508.

The board processing unit 505 repeats the expression evaluation process of each row every time the user inputs or operates an element on the board. In doing so, as optimizations to reduce the calculation amount, there are a method of marking a row that has been evaluated once and not re-evaluating it unless there is a change, and a method of updating only rows and boards to which the influence of a changed card propagates.

Specifically, it is effective to represent reference relationships of cards, rows, and boards as an acyclic dependency graph (DAG: Directed Acyclic Graph), apply topological sort to arrange them in order of propagation of influence, and evaluate values of cards, rows, and boards. In either case, it is necessary to prioritize evaluation of reference cards in row evaluation, and the expression evaluation process of FIG. 8 is applied.

When an acyclic dependency graph (DAG) is used, it can also serve as the circular reference detection data structure 507.

### Second Embodiment

The operator between cards may be designated by the user. However, since addition and subtraction between a price (a monetary amount with a currency symbol) and a quantity cannot occur when a user arranges a card of a monetary amount and a card of a numerical value as in the row 140, and the frequency of division is low, it is desirable for the row processing unit 504 to automatically place a multiplication operator 145. This has the effect of eliminating the need for the user to manually specify an operator.

### Third Embodiment

Next, an embodiment of “shopping selection” for selecting what to purchase from a plurality of articles and services that are purchase candidates and a price simulation will be described.

In FIG. 6, the card 112 for Food A is selected from the cards for the three foods in the row 110 and moved to the row 120 for the food unit price. Here, when the row 120 is at a distant position, there is a problem that it is difficult to move the card on the screen. In addition, when it is desired to simulate a change in price by replacing with Food B, the operation of returning the card 112 to the row 110 and inserting the card 113 is complicated. Furthermore, there is also a problem that the number of cards in the moving source row decreases, and it becomes impossible to know that there were options for three foods.

In order to solve these problems, a “selection operation” is introduced and defined as an operation in which the numerical value of the leftmost (topmost) card is set as the numerical value of the row in the row operation. A row for which a selection operation is set as a row operation is called a selection row.

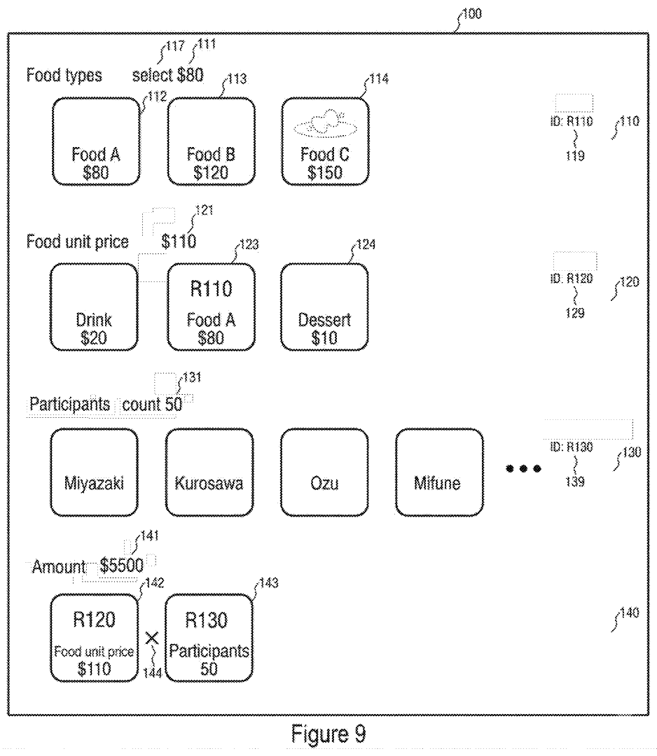

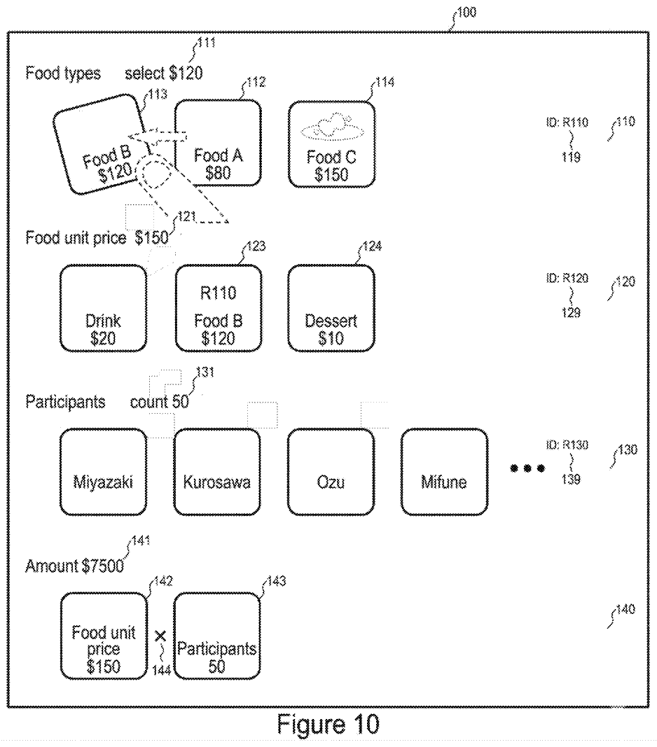

FIGS. 9 and 10 show an example of the selection operation. A selection operation is set as shown at 117 of the row 110 to form a selection row, and then a reference card 123 referring to the row 110 is put in the row 120 for the food unit price. At this point, the food unit price 121 is $110.

When the card 113 for Food B is moved to the leftmost as shown in FIG. 10, the numerical value 111 of the row becomes $120, which is the same as that of Food B. At the same time, the reference card 123 also becomes Food B, and the food unit price 121, the reference card 142, and the amount 141 change.

The selection operation provides the effect of improving the convenience of shopping selection for choosing one from a plurality of purchase candidates and price simulation. In addition, the effect of allowing a user to swap the selected card within a row with a single movement, and the effect of preserving the cards in the source row without loss, are also achieved.

In contrast, in the case of a spreadsheet, when referring to “the leftmost cell of a certain row,” if a formula such as “=A1” is simply used, the reference will no longer point to the leftmost cell if a new column is inserted to the left. There is no simple method for a general user to maintain such a reference without combining complex functions or using macros.

### Fourth Embodiment

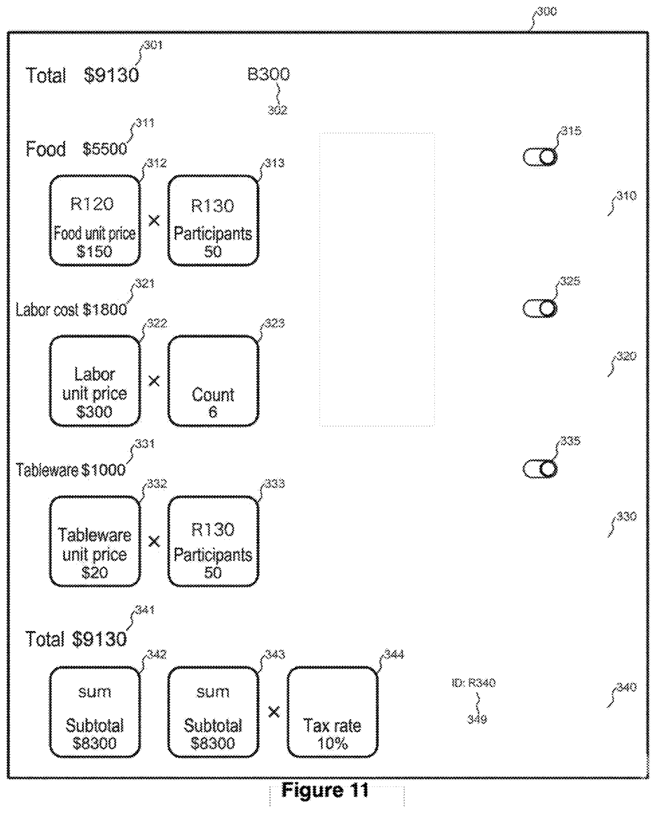

Next, an embodiment of creating an estimate without the need for inputting an expression will be described with reference to FIG. 11.

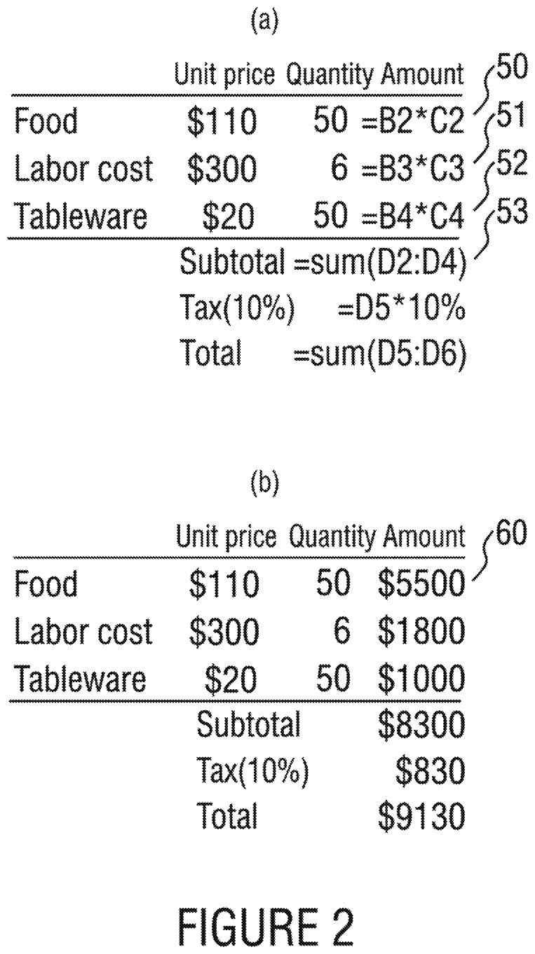

In FIG. 2, five formulas are required to create a food estimate including tax from the unit price of food, tableware rental, and labor costs, and the number of participants, using a spreadsheet. The goal is to achieve this without inputting even a single formula.

In FIG. 11, similarly to FIG. 2, there are rows for food 310, labor cost 320, and tableware 330, and their respective amounts are displayed. Since an amount card and a quantity card are arranged side by side in each row, multiplication operators are automatically inserted.

Here, in order to calculate the subtotal of those amounts, an “aggregation card” is introduced, and is defined as a reference card that performs an aggregation operation of designated rows.

Cards 342 and 343 in a row 340 are the same aggregation cards, and hold $8300 obtained by aggregating the amounts in the rows for food 310, labor cost 320, and tableware 330. Adding a 10% tax to the subtotal $8300 results in $9130 for a numerical value 341 of the row.

The range of rows to be aggregated by the aggregation card may be specified by any means, but an instruction input unit such as a switch 315 is visual and easy to use even for a user who does not know a notation such as a range specification in a spreadsheet.

In addition, a form based on a rule that a row of unit price times quantity is regarded as a range, a form in which a row in a designated range is colored, a form in which selection is performed by AI, a form similar to a range specification in a spreadsheet, and a form using a plurality of aggregation cards by multiple sets of specification means are also effective.

As described above, an example in which estimate calculation is performed without inputting a mathematical formula by using row operations and aggregation cards has been shown.

### Fifth Embodiment

An embodiment in which task management and budget management are integrated using a wedding as an example will be described with reference to FIG. 12.

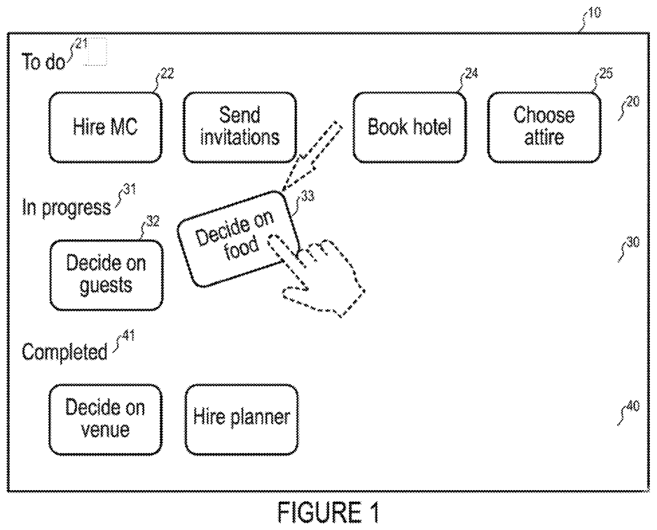

This is an expansion of the “wedding task management” of FIG. 1. A board 10 includes rows 20, 30, and 40 such as the aforementioned “to do” and cards indicating tasks.

In an added row 50, cards before task execution, at a stage where all the cards were in the “to do” row 20, are arranged. For example, the food budget is estimated at $8000, and the initial budget is $13250.

The “decide food” card 33 in the row 30 containing the currently executed task is a reference card to the row 340 in FIG. 11 or a reference card to a numerical value 301 of the board. Currently, it is in the middle of a simulation for selecting food, and in the case of the food currently selected by chance, it is $9130.

A numerical value 301 is a numerical value of a board and is used for reference to a board. Possible designation methods include a form in which an instruction input unit such as a switch is added to a row that becomes a numerical value of the board, a form in which a row is specified by a board attribute, a form in which a numerical value of a top or bottom row is used as a numerical value of the board, and a form in which the same numerical value as an aggregation card is used as a numerical value of the board.

The amount of the card included in the row 40 where execution has been completed is the amount that has been tentatively determined or already spent.

The row 60 includes a reference card 63 to the initial budget and an aggregation card 65 that aggregates the amounts in the rows 20, 30, and 40 at the current time, and these are connected by a subtraction operator 64.

The row operation of the row 60 reveals that a numerical value 62, that is, the remaining amount of the budget is −$900. Unfortunately, the budget is insufficient, so it seems better to reduce the number of participants (reduce the cards in the row 130) or choose a cheaper food (select Food A in the row 110).

As tasks proceed while keeping within the budget in this way, the number of uncompleted task cards in the row 20 decreases, the number of completed task cards in the row 40 increases, and the budget is fixed. This shows the effect of integrating task management and budget management.

Furthermore, in the past, managing a budget with a spreadsheet calculation required inputting a plurality of formulas, but in this example, budget management is realized by merely specifying a subtraction operator 64 without inputting any formula.

As another embodiment, setting a budget amount as a board attribute and displaying a numerical value (total) of the board and a difference thereof is convenient because the total and the remaining amount are displayed without adding the row 60.

If the tasks included in FIG. 12 are reference cards to boards for calculating the budget of each task, a budget plan for the entire wedding can be created without inputting a single formula, and execution can also be managed.

### Sixth Embodiment

Now, if only one user makes such a plan, it is assumed that differences of opinion will arise between a couple before marriage, leading to an alarming situation. If a plurality of users can use it simultaneously over a network, plans can be made while consulting.

Therefore, if a communication unit 509 of FIG. 7 mutually transmits operations of the respective users, cards on the board of another user move by one's own operation, and cards on one's own board move by an operation of another user. In doing so, in order not to cause inconsistency when a plurality of persons move the same card at the same time, if a server (not shown) relays the data to store it in a database and perform transaction processing, a plurality of users such as a couple, family members, and a wedding planner can use it. For example, a mode in which a card such as “May happiness be with you both for a long time.” is added is conceivable.

As described above, a new user interface has been disclosed that integrates task management by moving cards, product selection, and spreadsheet-like price simulation and budget management in a Kanban-style board by regarding a sequence of cards included in a row as an expression, setting a result of evaluating the expression thereof as a numerical value of the row, and incorporating a numerical value of another row into the expression by a reference card.

### INDUSTRIAL APPLICABILITY

The present invention is applicable in a wide range of industrial fields, including the information and communication industry, as an information processing apparatus, software, a non-transitory computer-readable medium, and a system in task management, project management, estimate creation, budget management, electronic commerce, and the like.

### REFERENCE SIGNS LIST

10, 100, 200, 300 Board
109 Board identifier
20, 30, 40, 110, etc. Row
114, etc. Card
118, etc. Card identifier
119, etc. Row identifier
141, etc. Numerical value of row
142, etc. Reference card
145, etc. Operator
146 Identifier of reference destination
315 Instruction input unit
342 Aggregation card
501 Input device. A general input means that converts user operations into electric signals, including a keyboard, a touch panel, a pointing device, a microphone, and the like.
502 Display device
503 Card processing unit
504 Row processing unit
505 Board processing unit
506 Data storage unit
507 Circular reference detection data structure
508 Expression data structure
509 Communication unit

What is claimed is:

1. An information processing apparatus implementing a Kanban board-style calculation user interface including one or more rows, each row having a row identifier and including one or more cards addable or movable by an input device, the apparatus comprising:
a processor;
a memory;
a board processing unit executable by the processor, holding a board having a capability of forming calculation expressions having dependencies from reference relationships defined by the row identifiers, between the cards displaying a numerical value and the rows, and performing evaluation of an expression of each row by dynamically reconstructing the expression and updating the numerical value in response to movement of the cards, without requiring expression input by a user;
a card processing unit executable by the processor to store, in the memory,
the one or more cards each being either a numerical value card displaying a title and a numerical value,
or a reference card storing the row identifier of a referenced row and displaying a numerical value of the referenced row;
a circular reference detection data structure stored in the memory for confirming that the reference card is not a circular reference; and
a row processing unit executable by the processor to store, in the memory, one or more rows each including:
a row identifier;
a list of the one or more cards and zero or more operators;
a numerical value of the row displayed on the row; and
an expression data structure storing an expression comprising numerical values displayed by the one or more cards and the zero or more operators,
the row processing unit, upon addition or movement of a card, repositioning other cards within the list, and each time retrieving the numerical values displayed by the one or more cards included in the row, evaluating using the expression data structure with the operator between the cards if present or as addition if no operator is present, and displaying the numerical value of the row as a result of the calculation;
wherein, in response to addition or movement of the card, the row processing unit is configured to, for evaluating the expression of each changed row:
sequentially retrieve one card or, if present, one of the operators from the list held by the row;
in a case where the retrieved card is a reference card, recursively evaluate an expression in a row referenced by the row identifier held by the reference card, after confirming that the reference card is not a circular reference using the circular reference detection data structure, and cause the reference card to store and display a numerical value of an obtained result;
in a case where the retrieved card is a numerical value card, retrieve the numerical value of the card from the card processing unit;
store the numerical value obtained in the foregoing cases or the retrieved operator, in the expression data structure in the memory;
after completing retrieval of all of the cards and, if present, the operators included in the list, evaluate, as an expression, the stored numerical values and, if present, the stored operators included in the expression data structure, with addition applied where no operator is present between numerical values, and display a result as a numerical value of the row; and
if the evaluation is performed as a recursive call, return the result to the row processing unit.

2. The information processing apparatus according to claim 1, wherein
the row processing unit is configured to:
automatically place a multiplication operator between such cards when a card of a monetary amount with a currency symbol and a card of a quantity are placed adjacently.

3. The information processing apparatus according to claim 1 or 2, wherein
in the evaluation of the expression, a numerical value of the card located at a leftmost or a topmost position is used as the numerical value of the row.

4. The information processing apparatus according to claim 1 or 2, wherein
types of the reference card include an aggregation card that displays a total value of numerical values of one or more rows designated by an instruction input unit relating to a row or the input device.

5. An information processing method in a Kanban board-style calculation user interface including one or more rows, each row having a row identifier and including one or more cards addable or movable by an input device,
performed by a processor executing:
a board processing unit holding a board having a capability of forming calculation expressions having dependencies from reference relationships defined by the row identifiers between the cards displaying a numerical value and the rows, and performing evaluation of an expression of each row by dynamically reconstructing the expression and updating the numerical value in response to movement of the cards, without requiring expression input by a user;
a card processing unit storing, in a memory, the one or more cards each being either a numerical value card displaying a title and a numerical value, or a reference card storing the row identifier of a referenced row and displaying a numerical value of the referenced row;
a circular reference detection data structure stored in the memory for confirming that the reference card is not a circular reference; and
a row processing unit storing, in the memory, one or more rows each including a row identifier, a list of the one or more cards and zero or more operators, a numerical value of the row displayed on the row, and an expression data structure storing an expression comprising numerical values displayed by the one or more cards and the zero or more operators, the row processing unit, upon addition or movement of a card, repositioning other cards within the list, and each time retrieving the numerical values displayed by the one or more cards included in the row, evaluating using the expression data structure with the operator between the cards if present or as addition if no operator is present, and displaying the numerical value of the row as a result of the calculation, the method comprising, by the row processing unit, in response to addition or movement of the card, for evaluating the expression of each changed row:
sequentially retrieving one card or, if present, one of the operators from the list;
in a case where the retrieved card is a reference card, recursively evaluating an expression in a row referenced by the row identifier held by the reference card, after confirming that the reference card is not a circular reference using the circular reference detection data structure, and causing the reference card to store and display a numerical value of an obtained result;
in a case where the retrieved card is a numerical value card, retrieving the numerical value of the card from the card processing unit;
storing the numerical value obtained in the foregoing cases or the retrieved operator, in the expression data structure in the memory;
after completing retrieval of all of the cards and, if present, the operators included in the list, evaluating, as an expression, the stored numerical values and, if present, the stored operators included in the expression data structure, with addition applied where no operator is present between numerical values, and displaying a result as a numerical value of the row; and
if the evaluation is performed as a recursive call, returning the result to a caller row processing unit.

6. The information processing method according to claim 5, wherein
the row processing unit is configured to:
automatically place a multiplication operator between the two cards when a card of a monetary amount with a currency symbol and a card of a quantity are placed adjacently as a result of the addition or the movement of the card.

7. The information processing method according to claim 5 or 6, wherein
in the evaluation of the expression, a numerical value of the card located at a leftmost or a topmost position is used as the numerical value of the row.

8. The information processing method according to claim 5 or 6, wherein
types of the reference card include an aggregation card that displays a total value of numerical values of one or more rows designated by an instruction input unit relating to a row or the input device.

9. The information processing apparatus according to claim 1, wherein
the board holds a numerical value of the board,
types of the card include a board reference card that references and displays a numerical value of another board, and
the row processing unit uses a numerical value of the board reference card for the evaluation of the expression.

10. A non-transitory computer-readable medium storing instructions that, when executed by a processor, cause a computer to perform the information processing method according to claim 5.
